(19) United States
(12) Patent Application Publication
(10) Pub. No.: US 2008/0169722 A1
(43) Pub. Date: Jul. 17, 2008

(54) STATOR CORE

(75) Inventor: Sung-Shan Ho, Taichung Hsien (TW)

Correspondence Address: DARBY & DARBY P.C., P.O. BOX 770, Church Street Station, New York, NY, 10008-0770, US

(73) Assignee: Q IN PRECISION INDUSTRIES CO., LTD., Taichung Hsien (TW)

(21) Appl. No.: 11/838,583

(22) Filed: Aug. 14, 2007

(30) Foreign Application Priority Data
Jan. 12, 2007 (TW) 096101270

(51) Int. Cl. H02K 1/12

(52) U.S. Cl. 310/217; 310/67 R; 310/254

(57) ABSTRACT

A stator core includes a laminated core member and a single-piece insulating layer. The laminated core member includes: a central ring portion defining an axis, and having first top and first bottom sides disposed opposite to each other, and an outer periphery extending from the first top side to the first bottom side; and at least two coil mounting portions extending radially and outwardly from the central ring portion, and angularly spaced apart relative to the axis. Each of the coil mounting portions has a second top side extending contiguously from the first top side, a second bottom side extending contiguously from the first bottom side, and a pair of coil winding surfaces extending from the second top side to the second bottom side. The insulating layer covers the top and bottom sides, the coil winding surfaces, and segments of the outer periphery between the coil mounting portions.

### CROSS-REFERENCE TO RELATED APPLICATION

This application claims priority of Taiwanese Application No. 096101270, filed on Jan. 12, 2007.

### BACKGROUND OF THE INVENTION

1. Field of the Invention

The invention relates to a stator core, more particularly to a stator core with a relatively secure structure.

2. Description of the Related Art

As shown in FIG. 1, FIG. 2 and FIG. 3, a conventional stator core 1 includes an upper insulating frame 11, a lower insulating frame 12 disposed opposite to and spaced apart from the upper insulating frame 11, and a silicon steel laminated core member 13 clamped between the upper and lower insulating frames 11, 12.

The laminated core member 13 includes a central ring portion 131 that defines an opening 130 along an axis (I), a plurality of rib portions 132 extending radially from the central ring portion 131, and a plurality of circumferential blocking portions 133 respectively on the rib portions 132. The central ring portion 131, the rib portions 132, and the circumferential blocking portions 133 cooperate to define a plurality of coil winding slots 134.

Each of the upper and lower insulating frames 11, 12 includes a main body portion 111, 121, and a plurality of coupling portions 112, 122 extending from the main body portion 111, 121 toward the laminated core member 13 so as to engage respectively in the coil winding slots 134. The lower insulating frame 12 is formed with a plurality of positioning grooves 123 that are angularly spaced apart from each other about the axis (I), and that are each adapted for insertion of a corresponding terminal 14 therein. To form a stator assembly, the conventional stator core 1 is assembled with a plurality of enameled wires 10. First, the coupling portions 112, 122 of the upper and lower insulating frames 11, 12 are engaged in the coil winding slots 134 in the laminated core member 13. Then the enameled wires 10 are wound subsequently around the rib portions 132 so as to provide a more secure integration among the upper and lower insulating frames 11, 12 and the laminated core member 13. Leads 101 of the enameled wires 10 remained after winding is completed are secured by the terminals 14, respectively.

As shown in FIG. 3 and FIG. 4, after the enameled wires 10 have been wound, the assembled stator assembly is applied to a heat dissipating fan 15. The heat dissipating fan 15 includes an axle 151, and a securing copper sleeve 16, which is received securely in the opening 130 defined by the central ring portion 131 of the laminated core member 13. After inserting the axle 151 into the securing copper sleeve 16, the heat dissipating fan 15 is fully integrated with the stator assembly incorporating the conventional stator core 1. By passing electricity through the enameled wires 10, magnetic forces are generated in the stator assembly such that the fan 15 is driven rotatably thereby.

However, the conventional stator core 1 has the following shortcomings:

1. The upper and lower insulating frames 11, 12 need to be formed separately, and then are coupled to the laminated core member 13 manually. Since manual assembly is required, manufacturing time and production cost are relatively high.

2. The upper and lower insulating frames 11, 12 are engaged loosely with the laminated core member 13 by engaging the coupling portions 112, 122 in the coil winding slots 134. It is only after the enameled wires 10 are wound around the rib portions 132 of the laminated core member 13 that the upper and lower insulating frames 11, 12 are secured to the laminated core member 13. In other words, prior to forming a stator assembly with the enameled wires 10, the conventional stator core 1 on its own is not a secure structure. The enameled wires 10 are necessary for preventing the upper and lower insulating frames 11, 12 from disengaging from the laminated core member 13. If the enameled wires 10 are not wound tight enough, it is easy for the upper and lower insulating frames 11, 12 to become loose and disengage from the laminated core member 13. On the other hand, if the enameled wires 10 are wound too tight, the upper and lower insulating frames 11, 12 may easily deform at peripheries thereof. Therefore, the conventional stator core 1 does not have a secure structure, and damage rate thereof is high.

3. The positioning grooves 123 are formed when manufacturing the lower insulating frame 12. Since the positioning grooves 123 normally do not extend through the lower insulating frame 12, and since the lower insulating frame 12 is usually relatively thin, depth of the positioning grooves 123 is usually not sufficient for securing tightly the terminals 14. This adversely affects the securing of the leads 101 of the enameled wires 10 when forming the stator assembly, and thereby adversely affects the functionality of the conventional stator core 1.

### SUMMARY OF THE INVENTION

Therefore, the object of the present invention is to provide a stator core that includes a single-piece insulating layer for providing a secure structure, and for enhancing stability in functionality of the stator core.

According to the present invention, there is provided a stator core that includes a laminated core member and a single-piece insulating layer.

The laminated core member includes a central ring portion and at least two coil mounting portions. The central ring portion defines an axis, and has a first top side and a first bottom side disposed opposite to each other, and an outer periphery extending from the first top side to the first bottom side. The coil mounting portions extend radially and outwardly from the central ring portion, and are angularly spaced apart from each other relative to the axis. Each of the coil mounting portions has a second top side that extends contiguously from the first top side, a second bottom side that is disposed opposite to the second top side and that extends contiguously from the first bottom side, and a pair of coil winding surfaces extending from the second top side to the second bottom side.

The single-piece insulating layer covers the first and second top sides, the first and second bottom sides, the coil winding surfaces, and segments of the outer periphery between the coil mounting portions.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional stator core;

FIG. 2 is an assembled perspective view of the conventional stator core;

FIG. 3 is a top view of a stator assembly formed by winding enameled wires around the conventional stator core;

FIG. 4 is a sectional view of a heat dissipating fan incorporating the stator assembly of FIG. 3;

FIG. 5 is an assembled perspective view of the first preferred embodiment of a stator core according to the present invention;

FIG. 6 is a perspective view of a laminated core member of the first preferred embodiment;

FIG. 7 is a side schematic view of the first preferred embodiment, illustrating an insulating layer covering the laminated core member;

FIG. 8 is a top view of the second preferred embodiment of a stator core according to the present invention; and

FIG. 9 is a sectional view of the second preferred embodiment taken along line IX-IX in FIG. 8.

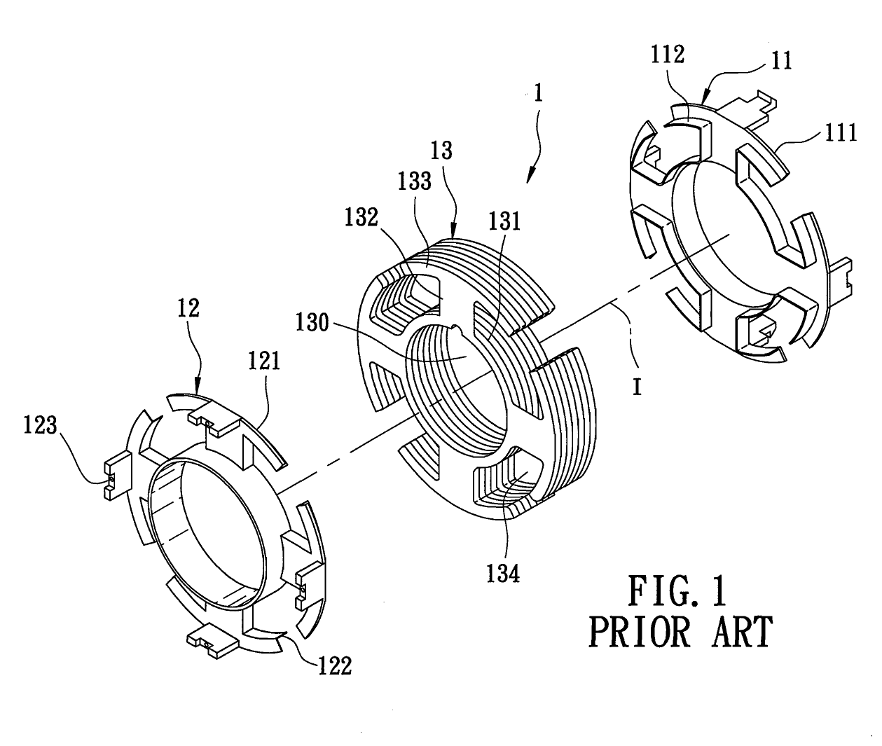

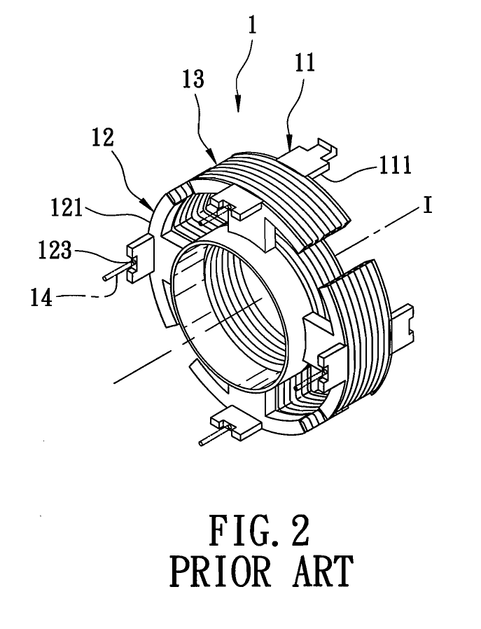

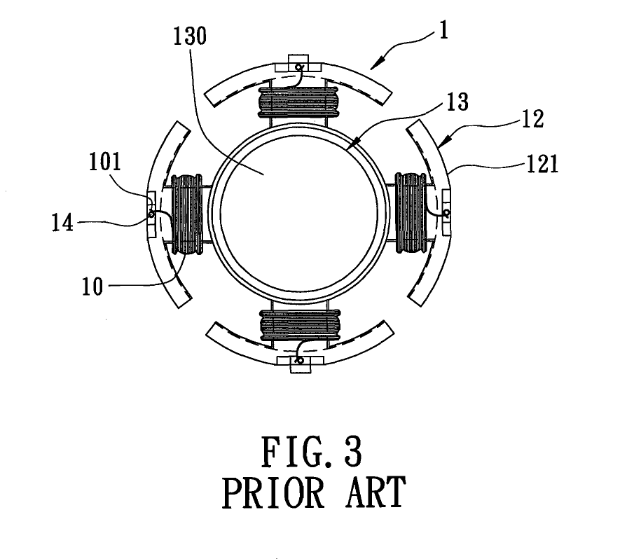

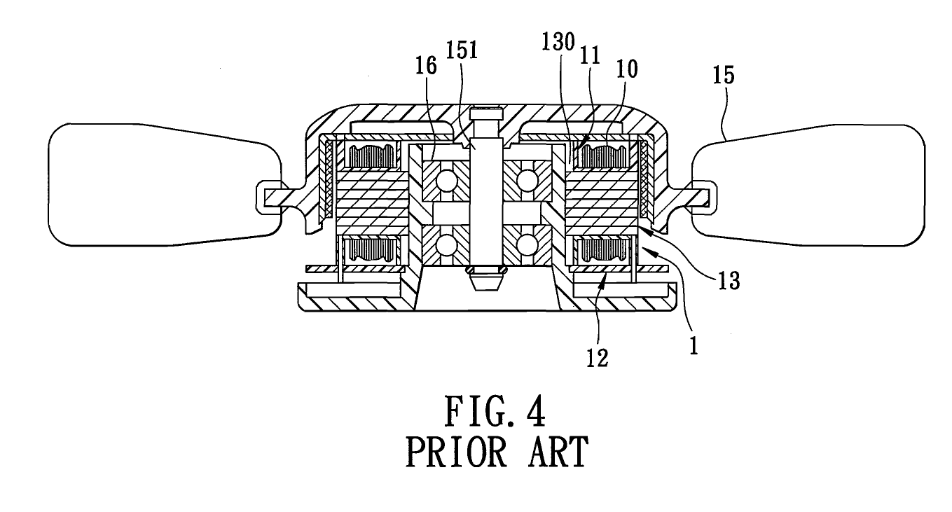

### DETAILED DESCRIPTION OF THE PREFERRED EMBODIMENTS

Before the present invention is described in greater detail, it should be noted herein that like elements are denoted by the same reference numerals throughout the disclosure.

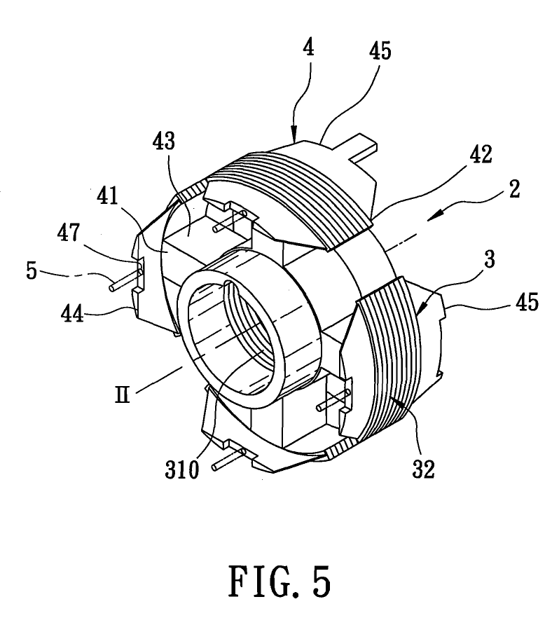

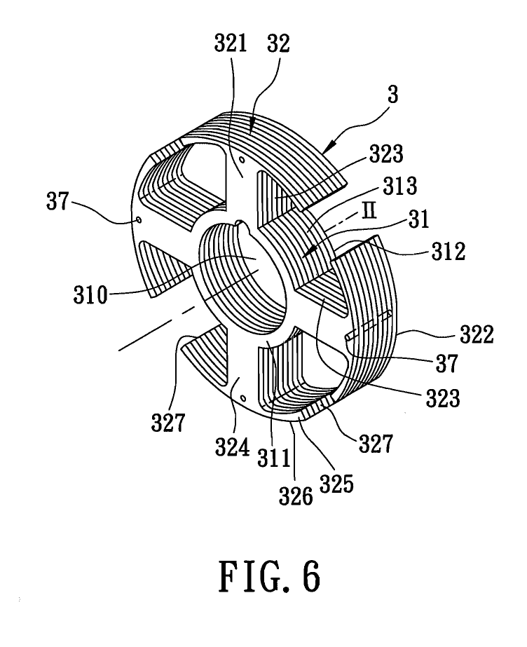

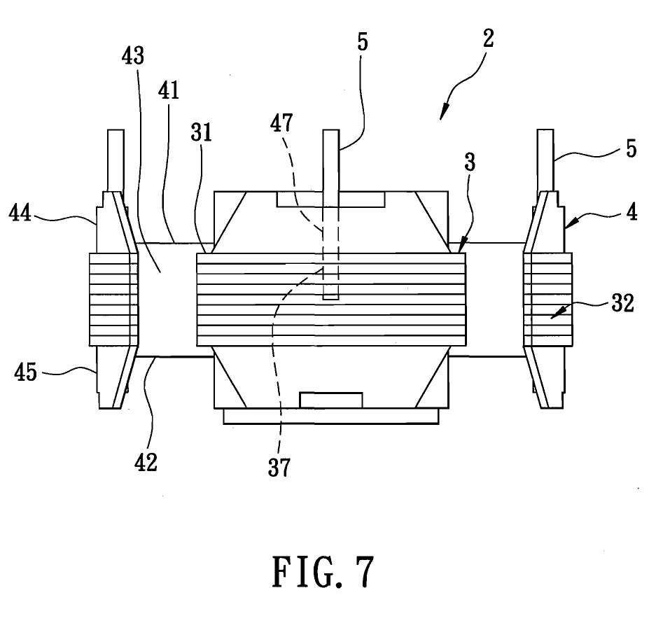

As shown in FIG. 5, FIG. 6 and FIG. 7, the first preferred embodiment of a stator core 2 according to the present invention includes a laminated core member 3 and a single-piece insulating layer 4.

The laminated core member 3 includes a central ring portion 31 that defines an opening 310 and an axis (II), and that has a first top side 311 and a first bottom side 312 disposed opposite to each other, and an outer periphery 313 extending from the first top side 311 to the first bottom side 312. The laminated core member 3 further includes at least two coil mounting portions 32 that extend radially and outwardly from the central ring portion 31, and that are angularly spaced apart from each other relative to the axis (II). Each of the coil mounting portions 32 includes a radial part 324 extending radially from the central ring portion 31, and a circumferential part 325 connected to one end of the radial part 324 opposite to the central ring portion 31. In addition, the laminated core member 3 is formed with a plurality of inner positioning grooves 37 that are angularly spaced apart from each other relative to the axis (II).

Each of the coil mounting portions 32 has a second top side 321 that extends contiguously from the first top side 311, a second bottom side 322 that is disposed opposite to the second top side 321 and that extends contiguously from the first bottom side 312, and a pair of coil winding surfaces 323 extending from the second top side 321 to the second bottom side 322. The radial part 324 of each of the coil mounting portions 32 is formed with the pair of the coil winding surfaces 323, and the circumferential part 325 has a surrounding surface 326 and two side faces 327 disposed at opposite ends of the surrounding surface 326.

The single-piece insulating layer 4 is made integrally from a plastic material, and covers the first and second top sides 311, 321, the first and second bottom sides 312, 322, the coil winding surfaces 323, and segments of the outer periphery 313 between the coil mounting portions 32.

The insulating layer 4 is formed with a plurality of outer positioning holes 47 that are respectively disposed in spatial communication with the inner positioning grooves 37.

The insulating layer 4 includes a first insulating portion 41 disposed to cover the first and second top sides 311, 321, a second insulating portion 42 disposed to cover the first and second bottom sides 312, 322, and a plurality of third insulating portions 43 connected between the first and second insulating portions 41, 42, and disposed to cover the coil winding surfaces 323 and the segments of the outer periphery 313 between the coil mounting portions 32.

The insulating layer 4 further includes a plurality of first protecting projections 44 extending from the first insulating portion 41 parallel to the axis (II), and angularly spaced apart from each other relative to the axis (II), and a plurality of second protecting projections 45 extending from the second insulating portion 42 parallel to the axis (II), and angularly spaced apart from each other relative to the axis (II). The inner positioning grooves 37 are disposed proximate to an outer peripheral edge of the laminated core member 3. The outer positioning holes 47 extend respectively through the first protecting projections 44 and through the first insulating portion 41, and are respectively disposed in spatial communication with the inner positioning grooves 37. The outer positioning grooves 47 are adapted respectively for insertion of a plurality of terminals 5 therein so as to fix the leads of a plurality of enameled wires (not shown) that are to be wound around the stator core 2 when forming a stator assembly with the stator core 2. Since the outer positioning grooves 47 are registered with and disposed in spatial communication with the inner positioning grooves 37, respectively, insertion depth of the terminals 5 extends through the insulating layer 4 and into the laminated core member 3, thereby providing a better positioning effect for the terminals 5 as compared to the prior art. It should be noted herein that it is not necessary for the insulating layer 4 to be provided with the first and second protecting projections 44, 45. As shown in FIG. 9, in the second preferred embodiment of a stator core 2′ according to the present invention, where the first and second protecting projections 44, 45 are absent, by forming the outer positioning grooves 47 directly in the first insulating portion 41′, secure insertion of the terminals 5 (shown in FIG. 5) can still be provided.

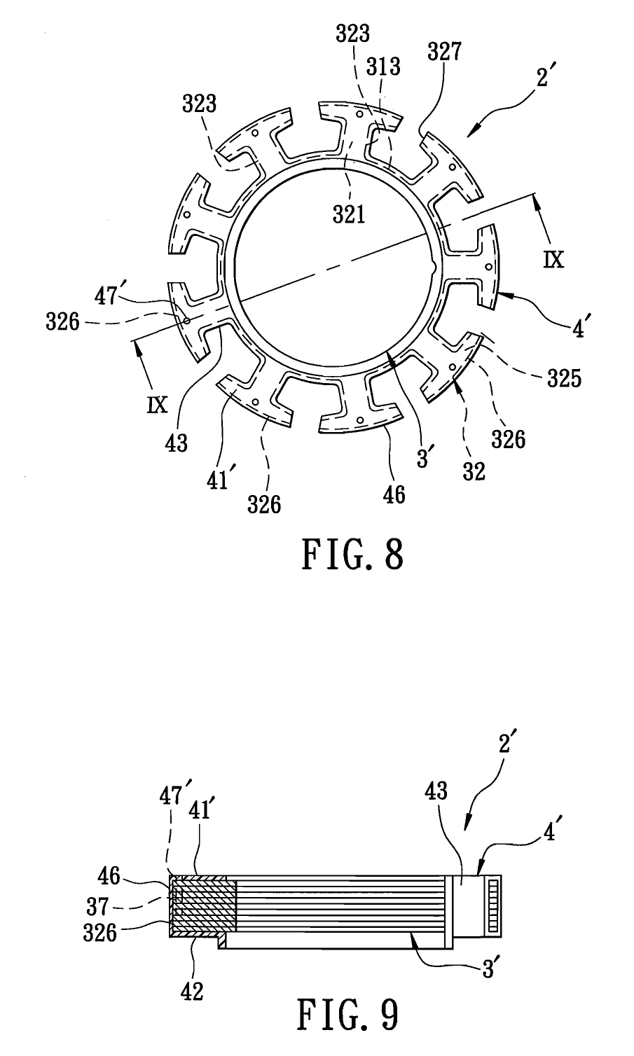

Referring again to FIG. 5 and FIG. 6, in the first preferred embodiment, the laminated core member 3 includes four of the coil mounting portions 32 angularly spaced apart from each other relative to the axis (II). Therefore, there are four circumferential parts 325 angularly spaced apart from each other relative to the axis (II), with each coil mounting portion 32 contributing one circumferential part 325. It should be noted herein that two coil mounting portions 32 are sufficient for providing a structure for the enameled wires (not shown) to wind therearound so as to form a stator assembly. Therefore, the number of coil mounting portions 32 can be any number greater than two as is required by a particular design, and is not limited to that disclosed in this embodiment. Preferably, the number of coil mounting portions 32 is between 2 to 12. As shown in FIG. 8 and FIG. 9, in the stator core 2′ according to the second preferred embodiment, the laminated core member 3′ is designed to include nine of the coil mounting portions 32 so that there are nine circumferential parts 325 in total. When the laminated core member 3′ includes nine of the coil mounting portions 32 such that the stator core 2′ is a nine-legged stator core, after forming a stator assembly with the enameled wires and incorporated in a rotating device (not shown), vibrational deviations and operating noise generated, and electric power required are less than those associated with a four-legged stator core, an example of which is the stator core 2 (shown in FIG. 5) of the first preferred embodiment. Consequently, a stator core with a higher number of coil mounting portions 32 is suitable for use in a motor of a precision instrument, such as a DVD player, where low deviation, low noise and energy-saving is required. On the other hand, a stator core with a lower number of coil mounting portions 32 is suitable for use in a motor of a fan or a heat dissipating fan, where low-cost is a general requirement.

It should be noted herein that in the second preferred embodiment, the insulating layer 4′ further covers the surrounding surfaces 326 of the circumferential parts 325 of the coil mounting portions 32. In particular, the insulating layer 4′ further includes a plurality of fourth insulating portions 46 connected between the first and second insulating portions 41, 42, and covering the surrounding surfaces 326 so as to provide a more complete protecting and insulating effect. To form a stator assembly, the stator core 2′ is assembled with a plurality of enameled wires (not shown), where each of the enameled wires is wound around the second top side 321, the coil winding surfaces 323 and the second bottom side 322 of a corresponding one of the coil mounting portions 32. As shown in FIG. 8, the fourth insulating portions 46 and the third insulating portions 43 are not connected such that the side faces 327 of the circumferential parts 325 are not covered by the insulating layer 4′. However, the side faces 327 can also be covered by the insulating layer 4′, in which case the fourth insulating portions 46 are connected to the third insulating portions 43, respectively. Whether the insulating layer 4′ covers the side faces 327 or not does not affect the insulating effect on the enameled wires, nor does it affect the functionality of the stator core 2′.

In sum, the stator core 2, 2′ according to the present invention is capable of achieving the following effects and advantages:

1. Since the present invention includes an integrally-formed single-piece insulating layer 4, 4′ for covering the first and second top sides 311, 321, the first and second bottom sides 312, 322, the coil winding surfaces 323, and segments of the outer periphery 313 between the coil mounting portions 32, manual assembly is no longer necessary, thereby simplifying the manufacturing procedure. Consequently, manufacturing time and production cost are both reduced for the present invention as compared to the prior art.

2. Since the insulating layer 4, 4′ is formed integrally around the laminated core member 3, 3′, coupling between the insulating layer 4, 4′ and the laminated core member 3, 3′ is secure and stable. This secure structure of the stator core 2, 2′ makes it convenient to wind the enameled wires therearound when forming a stator assembly, and assistance of the enameled wires in securing the structure is no longer necessary. Consequently, it is less likely for the enameled wires to break and for the stator core 2, 2′ to deform due to excess tension exerted on the enameled wires, thereby reducing the damage rate of the stator core 2, 2′.

3. Since the outer positioning grooves 47, 47′ in the insulating layer 4, 4′ are respectively registered with and disposed in spatial communication with the inner positioning grooves 37 in the laminated core member 3, the terminals 5 can be inserted through the insulating layer 4, 4′ and into the laminated core member 3, 3′ for securing the leads of the enameled wires. Because the insertion depth of the terminals 5 in the present invention is greater than that of the prior art, when the stator core 2, 2′ is used to form a stator assembly with the enameled wires, the leads of the enameled wires can be secured more tightly, thereby enhancing the stability in the functionality of the stator core 2, 2′.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A stator core comprising:
a laminated core member including
a central ring portion that defines an axis, and that has a first top side and a first bottom side disposed opposite to each other, and an outer periphery extending from said first top side to said first bottom side, and
at least two coil mounting portions that extend radially and outwardly from said central ring portion, and that are angularly spaced apart from each other relative to the axis, each of said coil mounting portions having a second top side that extends contiguously from said first top side, a second bottom side that is disposed opposite to said second top side and that extends contiguously from said first bottom side, and a pair of coil winding surfaces extending from said second top side to said second bottom side; and
a single-piece insulating layer covering said first and second top sides, said first and second bottom sides, said coil winding surfaces, and segments of said outer periphery between said coil mounting portions.

2. The stator core as claimed in claim 1, wherein said laminated core member is formed with a plurality of inner positioning grooves that are angularly spaced apart from each other relative to the axis, said insulating layer being formed with a plurality of outer positioning holes that are respectively disposed in spatial communication with said inner positioning grooves.

3. The stator core as claimed in claim 2, wherein said insulating layer includes a first insulating portion disposed to cover said first and second top sides, a second insulating portion disposed to cover said first and second bottom sides, and a third insulating portion connected between said first and second insulating portions, and disposed to cover said coil winding surfaces and said segments of said outer periphery between said coil mounting portions, said outer positioning holes being formed through said first insulating portion.

4. The stator core as claimed in claim 3, wherein said insulating layer further includes a plurality of first protecting projections extending from said first insulating portion parallel to the axis, and angularly spaced apart from each other relative to the axis, and a plurality of second protecting projections extending from said second insulating portion parallel to the axis, and angularly spaced apart from each other relative to the axis, said inner positioning grooves being disposed proximate to an outer peripheral edge of said laminated core member, said outer positioning holes extending respectively through said first protecting projections and through said first insulating portion.

5. The stator core as claimed in claim 1, wherein each of said coil mounting portions includes a radial part extending radially from said central ring portion, and formed with the pair of said coil winding surfaces, and a circumferential part connected to one end of said radial part opposite to said central ring portion and having a surrounding surface.

6. The stator core as claimed in claim 5, wherein said insulating layer further covers said surrounding surfaces.
